(19) United States
(12) Patent Application Publication
(10) Pub. No.: US 2023/0347688 A1
(43) Pub. Date: Nov. 2, 2023

(54) APPARATUS FOR AFFIXING AN ACCESSORY TO A GATE

(71) Applicant: United States Marketing Corp., Middleburgh, NY (US)

(72) Inventor: Theodore J. Werner, Middleburgh, NY (US)

(21) Appl. No.: 17/733,053

(22) Filed: Apr. 29, 2022

(51) Int. Cl. B60B 33/00; E06B 11/02

(52) U.S. Cl. CPC B60B 33/0005; E06B 11/02

(57) ABSTRACT

Disclosed embodiments provide an apparatus for affixing an accessory (e.g., a wheel) to a gate. These include a bracket that has a first planar member and a set of secondary planar members affixed to the first planar member and extend perpendicularly outward from the first planar member to which an accessory can be mounted. Also included are a set of fasteners that have a curved intermediate section that has a planar interior surface and first and second parallel ends that are adapted to extend through oblong shaped apertures in the first parallel surface and are fastened to the first parallel surface with a set of parallel end fasteners coupled to the first and second parallel ends.

### FIELD

Disclosed embodiments relate generally to gated entryways. More specifically, embodiments of the disclosed invention relate to a removable apparatus for affixing an accessory to a gate.

### BACKGROUND

Fences are ubiquitous in the United States and around the world. Fences often delineate property lines or divide sections of a particular property according to different uses. They are often used to keep unauthorized humans and undesired animals out of an area and/or to keep domestic animal contained within the area.

Whatever the case, most fences have one or more gates for allowing people, vehicles, equipment, and/or the like to access the gated off area. In agricultural environments, these gates are often relatively long to allow vehicles, farm equipment, livestock, and/or the like to pass through. One of the most common types of gates is a 4-16-foot-long cattle gate that is made of tubular steel.

### SUMMARY

Disclosed embodiments provide an apparatus for affixing an accessory (e.g., a wheel) to a gate. These include a bracket that has a first planar member and a set of secondary planar members affixed to the first planar member and extend perpendicularly outward from the first planar member to which an accessory can be mounted. Also included are a set of fasteners that have a curved intermediate section that has a planar interior surface and first and second parallel ends that are adapted to extend through oblong shaped apertures in the first parallel surface and are fastened to the first parallel surface with a set of parallel end fasteners coupled to the first and second parallel ends.

In some embodiments, there is provided an apparatus for affixing an accessory to a gate comprising: a bracket having: a first planar member, having: a gate adjacent face; a gate opposite face; and a set of aperture pairs, each aperture pair of the set of aperture pairs having a pair of apertures oriented along a transverse axis of the first planar member, each aperture in the aperture pair being an oblong shape oriented along the transverse axis; and first and second secondary planar members affixed to the first planar member such that the first and second secondary planar members are oriented perpendicular to a longitudinal axis of the first planar member and extend perpendicularly outward from the first planar member, the first secondary planar member being parallel to the second secondary planar member, each of the secondary planar members having a corresponding aperture; a mounting apparatus, having: a set of fasteners, each fastener of the set of fasteners having a first and second parallel ends and a curved intermediate section, the curved intermediate section having a planar interior surface, the first and second parallel ends adapted to extend through the apertures in an aperture pair from the gate adjacent face to the gate opposite face; and a set of parallel end fasteners coupled to the first and second parallel ends, the set of parallel end fasteners coupling the set of fasteners to the first planar member of the bracket; a wheel; and an axle that functionally couples the wheel to the secondary planar members and that extends through the wheel and through the corresponding aperture of the secondary planar members.

In some embodiments, there is provided an apparatus for mounting an accessory to a gate comprising: a bracket having: a first planar member, having: a gate adjacent face; a gate opposite face; and a set of aperture pairs, each aperture pair of the set of aperture pairs having a pair of apertures oriented along a transverse axis of the first planar member, each aperture in the aperture pair being an oblong shape oriented along the transverse axis; and first and second secondary planar members affixed to the first planar member such that the first and second secondary planar members are oriented perpendicular to a longitudinal axis of the first planar member and extend perpendicularly outward from the first planar member, the first secondary planar member being parallel to the second secondary planar member, each of the secondary planar members having a corresponding coupling member; a mounting apparatus, having: a set of fasteners, each fastener of the set of fasteners having a first and second parallel ends and a curved intermediate section, the curved intermediate section having a planar interior surface, the first and second parallel ends adapted to extend through the apertures in an aperture pair from the gate adjacent face to the gate opposite face; and a set of parallel end fasteners coupled to the first and second parallel ends, the set of parallel end fasteners coupling the set of fasteners to the first planar member of the bracket.

In some further embodiments, there is provided an apparatus for mounting an accessory to a gate comprising: a bracket having: a first planar member, having: a gate adjacent face; a gate opposite face; and a set of aperture pairs, each aperture pair of the set of aperture pairs having a pair of apertures oriented along a transverse axis of the first planar member, each aperture in the aperture pair being an oblong shape oriented along the transverse axis; and a set of secondary planar members affixed to the first planar member such that each secondary planar member is oriented parallel to a longitudinal axis of the first planar member and extends perpendicularly outward from the first planar member, each secondary planar member having a coupling member; a mounting apparatus, having: a set of fasteners, each fastener of the set of fasteners having a first and second parallel ends and a curved intermediate section, the curved intermediate section having a planar interior surface, the first and second parallel ends adapted to extend through the apertures in an aperture pair from the gate adjacent face to the gate opposite face; and a set of parallel end fasteners coupled to the first and second parallel ends, the set of parallel end fasteners coupling the set of fasteners to the first planar member of the bracket.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 shows a perspective view of an embodiment of the present invention.

FIG. 2A is a top-down view of a first planar member.

FIG. 2B is a perspective view of the first planar member.

FIG. 2C is a front view of the first planar member.

FIG. 2D is a side view of the first planar member.

FIG. 3 shows a perspective view of a fastener according to an embodiment of the present invention.

FIG. 4 shows a perspective view of an embodiment of the present invention.

FIG. 5 shows a perspective view of another embodiment of the present invention.

The drawings are not necessarily to scale. The drawings are merely representations, not necessarily intended to portray specific parameters of the invention. The drawings are intended to depict only example embodiments of the invention, and therefore should not be considered as limiting in scope. In the drawings, like numbering may represent like elements. Furthermore, certain elements in some of the figures may be omitted, or illustrated not-to-scale, for illustrative clarity.

### DETAILED DESCRIPTION

Disclosed embodiments provide an apparatus for affixing an accessory (e.g., a wheel) to a gate. These include a bracket that has a first planar member and a set of secondary planar members affixed to the first planar member and extend perpendicularly outward from the first planar member to which an accessory can be mounted. Also included are a set of fasteners that have a curved intermediate section that has a planar interior surface and first and second parallel ends that are adapted to extend through oblong shaped apertures in the first parallel surface and are fastened to the first parallel surface with a set of parallel end fasteners coupled to the first and second parallel ends.

Reference throughout this specification to “one embodiment,” “an embodiment,” “some embodiments,” or similar language means that a particular feature, structure, or characteristic described in connection with the embodiment is included in at least one embodiment of the present invention. Thus, appearances of the phrases “in one embodiment,” “in an embodiment,” “in some embodiments,” and similar language throughout this specification may, but do not necessarily, all refer to the same embodiment.

Moreover, the described features, structures, or characteristics of the invention may be combined (“mixed and matched”) in any suitable manner in one or more embodiments. It will be apparent to those skilled in the art that various modifications and variations can be made to the present invention without departing from the spirit and scope and purpose of the invention. Thus, it is intended that the present invention cover the modifications and variations of this invention provided they come within the scope of the appended claims and their equivalents. Reference will now be made in detail to the preferred embodiments of the invention.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, or “has” and/or “having”, when used in this specification, specify the presence of stated features, regions, integers, steps, operations, elements, and/or components, but do not preclude the presence or addition of one or more other features, regions, and/or elements. For the purposes of disclosure, the word, “substantially” is defined as “for the most part.” It means “to a great extent,” but having some room for some minor variation.

The inventor of the current invention has discovered a number of deficiencies in current gate solutions. For example, the horizontal center of gravity of a gate is generally significantly removed from the post or other anchoring point that anchors the gate to the ground. This, combined with the fact that the portion of the gate opposite from the anchoring point, is generally off the ground and unsupported, causes stress to the gate and the anchoring point, which can cause the gate to sag toward the ground and/or for the anchoring point to move out of alignment over time. These problems are magnified as the length of the gate increases. Current solutions to this problem fail to account for differing sizes of materials making up the gate. Moreover, current solutions to this problem also fail to fasten securely to curved sections of the gate. The inventor has discovered that what is needed, inter alia, is a solution that securely supports the portion of a gate that is opposite the anchoring point, while facilitating easy opening and closing of the gate.

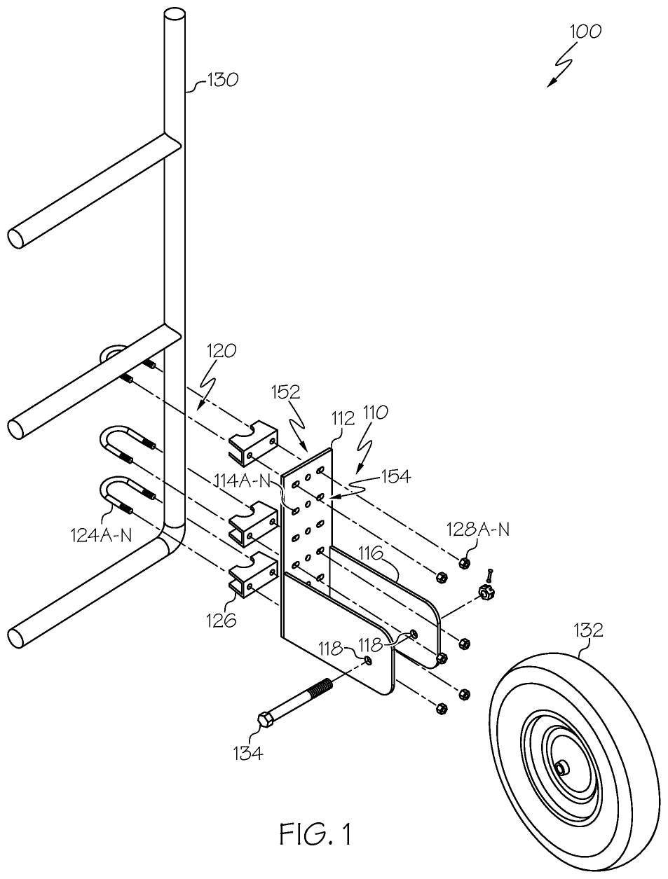

FIG. 1 shows a perspective view of an embodiment of the present invention. Device 100 includes a bracket 110. In an embodiment, bracket 110 can be made of stainless steel. However, it should be understood that any structurally rigid material, combination of materials, compound, etc., is envisioned, including, but not limited to, metals, carbon fiber, ceramics, cellulose, and/or the like. In any case, device 100 includes a bracket 110.

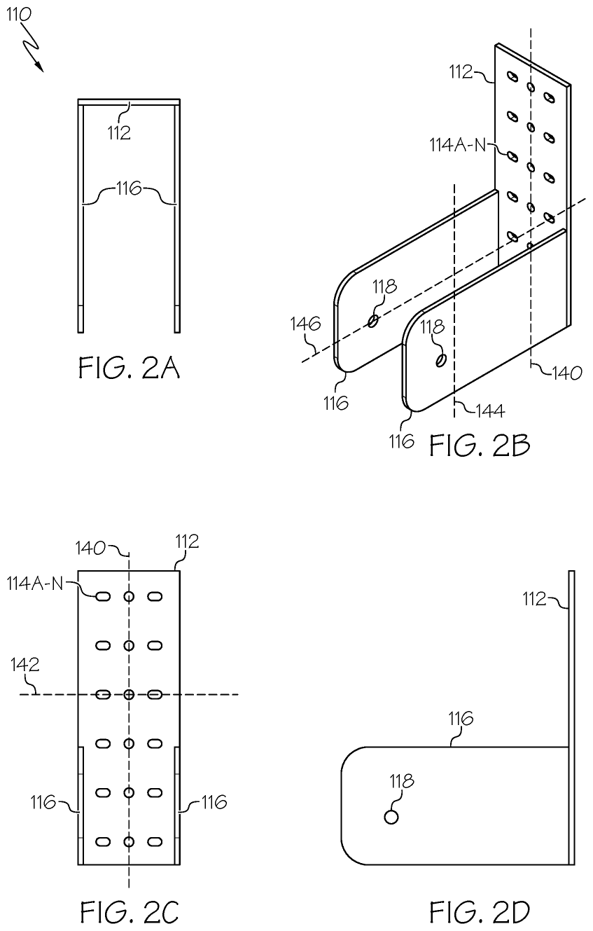

Referring now to FIG. 2A-D, a number of different views of bracket 110 are illustrated according to an embodiment of the invention. Referring additionally to FIG. 1, bracket 110 includes a first planar member 112. While, as illustrated, first planar member 112 is shown as being substantially rectangular, it should be understood that first planar member can take any shape that is now known or later developed. Whatever the case, first planar member 112 has a gate adjacent face 152, which is substantially planar and is oriented in the direction of a gate 130 when device 100 is mounted to gate 130. First planar member 112 also has a gate opposite face 154, which is substantially planer and is oriented in a direction that is opposite from gate 130 when device 100 is mounted to gate 130. Also included in first planar member 112 is a set of aperture pairs 114A-N. Each aperture pair 114N of the set of aperture pairs 114A-N includes a pair of apertures in first planar member 112. Each of the apertures in aperture pair 114N are oriented along a common axis 142 of first planar member 112. In an embodiment, the apertures in aperture pair 114N are oriented along a transverse axis 142 of first planar member 112, such as in cases in which first planar member 112 is to be affixed to one or more vertical tubular members. In an embodiment, the apertures in aperture pair 114N can be oriented along a longitudinal axis 142 of first planar member 112, such as in cases in which first planar member 112 is to be affixed additionally or alternatively to one or more horizonal tubular members. Moreover, the apertures in each aperture pair 114N can be spaced equidistant or substantially equidistant from a longitudinal axis 140 of first planar member 112. In any case, each aperture in aperture pair 114N is not merely circular in shape but is instead elongated along transverse axis 142 to form an oblong shape. In an embodiment, the aperture can be a stadium, which can be defined as a two-dimensional geometric shape constructed of a rectangle with semicircles at a pair of opposite sides. In other embodiments, the aperture can be rectangular, ovoid, ellipsoid, or any other oblong shape. In any case, these apertures extend completely through first planar member 112 between gate adjacent face 152 and gate opposite face 154.

Bracket 110 also includes a pair of secondary planar members 116 that are affixed to first planar member 112. Each of these secondary planar members 116 is oriented parallel to longitudinal axis 140 of first planar member 112 such that a transverse axis 144 of secondary planar members 116 is oriented parallel to longitudinal axis 140 of first planar member 112. These secondary planar members 116 extend perpendicularly outward from first planar member 112 such that a longitudinal axis 146 of secondary planar members 116 is perpendicular to a planar surface 152, 154 of first planar member 112. As illustrated, first and second secondary planar members 116 are shown as being affixed to the lateral edges of first planar member 112. However, it should be understood that secondary planar members 116 can be affixed to any part of first planar member 112 between longitudinal axis 140 and the lateral edges.

Whatever the case, each of secondary planar members 116 includes a coupling member 118. Coupling member 118 provides a structure on secondary planar members 116 to which an accessory 132 can be coupled via a coupler 134 to secondary planar members 116. It should be understood that although a wheel is shown in the figures, any accessory that may be desirable to affix to a gate is envisioned. In an embodiment, coupling member 118 can include a corresponding aperture in each of secondary planar members 116 that is adapted to accept coupler 134. In such an embodiment, coupler 134 can include an axle that functionally couples accessory 132 to secondary planar members 116 that extends through accessory 132 and through the corresponding apertures of secondary planar members 116. However, it should be understood that other solutions for coupling an accessory to a structure are within the scope of this invention.

Device 100 further includes a mounting apparatus 120. Mounting apparatus 120 is adapted to mount bracket 110 to gate 130.

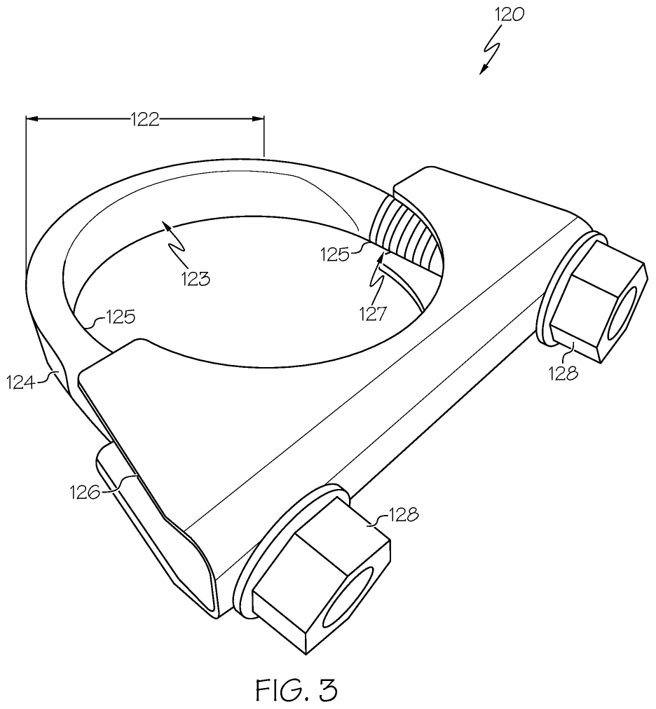

Referring now to FIG. 3, a perspective view of mounting apparatus 120 is shown according to an embodiment. Referring additionally to FIG. 1, mounting apparatus 120 includes a set of fasteners 124A-N. Each fastener 124 of set of fasteners 124A-N has a curved intermediate section 122. Curved intermediate section 122 of fastener 124 has a planar interior surface 123. Planar interior surface 123 abuts a tubular member of gate 130 when fastener 124 is used to affix bracket 112 to gate 130. Tubular member can be a vertical gate member, horizontal gate member, or any other tubular member of gate 130 that is now known or later developed. Because planar interior surface 123 is planar rather than rounded, as in current solutions, use of planar interior surface 123 causes a greater amount of surface area of curved intermediate section 122 to be in contact with the tubular member of gate 130 providing increased stability in affixing device 100 to gate 130. In addition, the fact that curved intermediate section 122 is flexible allows curved intermediate section 122 to conform to the tubular member of gate 130, helping to make the affixing more secure.

Fastener 124 also includes a pair of parallel ends 125. Parallel ends 125 are adapted to extend through the apertures in an aperture pair 114N from gate adjacent face 152 to gate opposite face 154.

Mounting apparatus 120 also includes a set of parallel end fasteners 128A-N. Parallel end fasteners are adapted to couple to parallel ends 125 and serve to couple fastener 120 to first planar member 112 of bracket 110 when parallel ends 125 are extended through the apertures in aperture pair 114N, removably affixing device 100 to the tubular member of gate 130. Moreover, the flexible nature of fastener 124, combined with the oblong shape of the apertures in aperture pair 114N allow mounting apparatus to securely affix device 100 to gates 130 having tubular members of differing diameters. In an embodiment, fastener 124 is a U-bolt, although other solutions are envisioned. In an embodiment, parallel ends 125 are threaded and set of end fasteners 128 are nuts, although other solutions are envisioned.

In an embodiment, mounting apparatus 120 can also include a saddle bracket 126. Saddle bracket includes a planar surface that is configured to abut gate adjacent face 152 of first planar member 112. Saddle bracket 126 also includes a curved portion that is opposite gate adjacent face 152 of first planar member 112 and is curved to conform to a surface of the tubular member of gate 130 that is adjacent to gate adjacent face 152 of first planar member 112. Saddle bracket 126 also includes a bracket aperture pair that corresponds to an aperture pair 114N of first planar member 112. Like the apertures of aperture pair 114N, apertures in bracket aperture pair are also oblong. When saddle bracket 126 is present, first and second parallel ends 125 are adapted to extend through the saddle bracket apertures in the saddle bracket aperture pair from the curved portion to the planar surface before extending through aperture pair 114N.

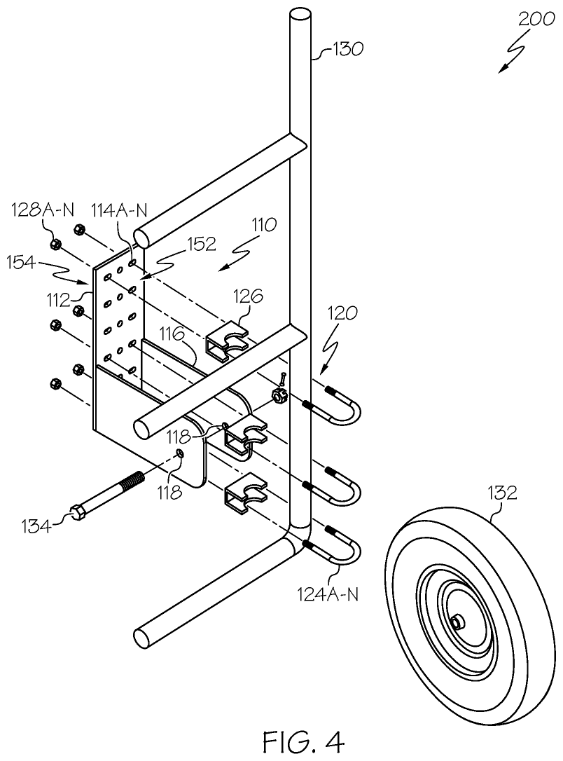

FIG. 4 shows a perspective view of an alternative embodiment of the present invention, presented herein as device 200 according to a further embodiment. In contrast to FIG. 1, in which secondary planar members 116 extend from gate opposite face 154, in FIG. 4, secondary planar members 116 extend from gate adjacent face 152, resulting in accessory 132 being on the opposite side of gate 130 from first planar member 112.

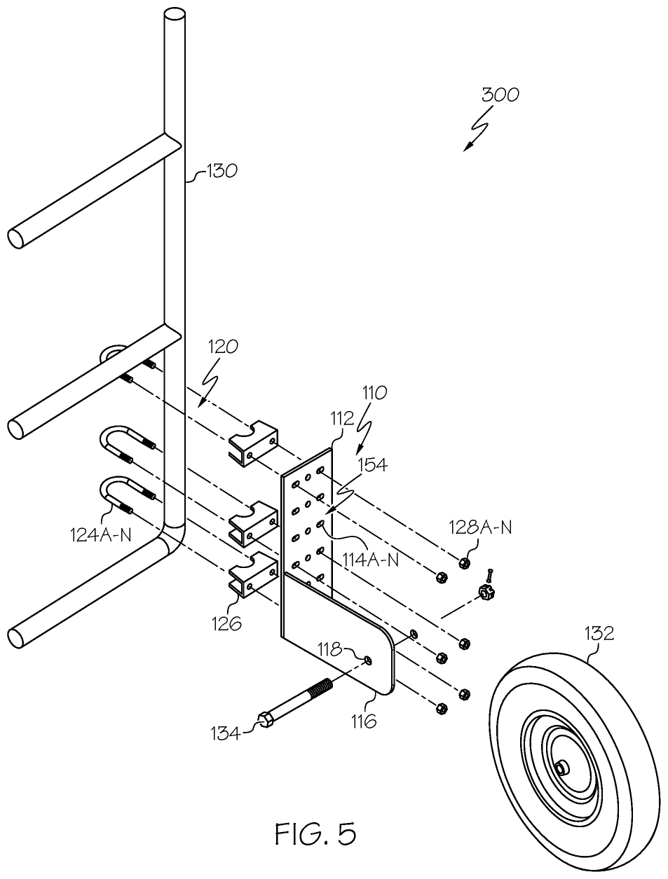

FIG. 5 shows a perspective view of still another alternative embodiment of the present invention, presented herein as device 300 according to a further embodiment. In contrast to FIG. 1, in which two opposite and parallel secondary planar members 116 extend from first planar member 112, in FIG. 5, a single secondary planar member 116 extends from first planar member 112. In this embodiment, coupler 134 comprises a cantilever axel for accessory 132. It is to be understood that in some embodiments bracket 110 comprises a set of secondary planar members 116, and that this set can comprise one or more secondary planar members 116.

It is further to be understood that components of bracket 110 as disclosed herein may be permutated along lines similar to the alternative embodiments shown in FIG. 4 and FIG. 5 while maintaining the true spirit of the present invention.

As can now be appreciated, disclosed embodiments provide an apparatus for affixing an accessory to a gate mounting device. While the invention has been particularly shown and described in conjunction with exemplary embodiments, it will be appreciated that variations and modifications will occur to those skilled in the art. The embodiments according to the present invention may be implemented in association with the formation and/or processing of structures illustrated and described herein as well as in association with other structures not illustrated. Moreover, in particular regard to the various functions performed by the above described components (assemblies, devices, etc.), the terms used to describe such components are intended to correspond, unless otherwise indicated, to any component which performs the specified function of the described component (i.e., that is functionally equivalent), even though not structurally equivalent to the disclosed structure which performs the function in the herein illustrated exemplary embodiments of the invention. In addition, while a particular feature of the invention may have been disclosed with respect to only one of several embodiments, such feature may be combined with one or more features of the other embodiments as may be desired and advantageous for any given or particular application. Therefore, it is to be understood that the appended claims are intended to cover all such modifications and changes that fall within the true spirit of the invention.

What is claimed is:

1. A apparatus for affixing an accessory to a gate comprising:
a bracket having:
a first planar member, having:
a gate adjacent face;
a gate opposite face; and
a set of aperture pairs, each aperture pair of the set of aperture pairs having a pair of apertures oriented along a transverse axis of the first planar member, each aperture in the aperture pair being an oblong shape oriented along the transverse axis; and
first and second secondary planar members affixed to the first planar member such that the first and second secondary planar members are oriented parallel to a longitudinal axis of the first planar member and extend perpendicularly outward from the first planar member, the first secondary planar member being parallel to the second secondary planar member, each of the secondary planar members having a corresponding aperture;
a mounting apparatus, having:
a set of fasteners, each fastener of the set of fasteners having a first and second parallel ends and a curved intermediate section, the curved intermediate section having a planar interior surface, the first and second parallel ends adapted to extend through the apertures in an aperture pair from the gate adjacent face to the gate opposite face; and
a set of parallel end fasteners coupled to the first and second parallel ends, the set of parallel end fasteners coupling the set of fasteners to the first planar member of the bracket;
a wheel; and
an axle that functionally couples the wheel to the secondary planar members and that extends through the wheel and through the corresponding apertures of the secondary planar members.

2. The apparatus of claim 1,
wherein the planar interior surface of the set of fasteners abuts a tubular member of a gate when in use, and
wherein the coupling of the set of fasteners to the first planar member of the bracket is configured to removably affix the apparatus to the tubular member of the gate.

3. The apparatus of claim 2, wherein the set of fasteners are flexible such that the interior surface of the set of fasteners is configured to adapt to a curved surface of the tubular member of the gate.

4. The apparatus of claim 1, the mounting apparatus further comprising a saddle bracket, having:
a planar surface that is configured to abut the gate adjacent face of the first planar member;
a curved portion opposite the gate adjacent face of the first planar member; and
a saddle bracket aperture pair that corresponds to an aperture pair of the first planar member, each saddle bracket aperture in the saddle bracket aperture pair being an oblong shape,
wherein the first and second parallel ends are adapted to extend through the saddle bracket apertures in the saddle bracket aperture pair from the curved portion to the planar surface.

5. The apparatus of claim 1,
wherein the set of fasteners comprise a U-bolt,
wherein the first and second parallel ends are threaded; and
wherein the set of end fasteners comprise a nut.

6. The apparatus of claim 1, wherein the first and second secondary planar members are affixed to opposing lateral edges of the first planar member.

7. The apparatus of claim 1, wherein the first and second secondary planar members extend from the gate adjacent face of the first planar member.

8. The apparatus of claim 1, wherein the first and second secondary planar members extend from the gate opposite face of the first planar member.

9. An apparatus for mounting an accessory to a gate comprising:
a bracket having:
a first planar member, having:
a gate adjacent face;
a gate opposite face; and
a set of aperture pairs, each aperture pair of the set of aperture pairs having a pair of apertures oriented along a common axis of the first planar member, each aperture in the aperture pair being an oblong shape oriented along the common axis; and
first and second secondary planar members affixed to the first planar member such that the first and second secondary planar members are oriented parallel to a longitudinal axis of the first planar member and extend perpendicularly outward from the first planar member, the first secondary planar member being parallel to the second secondary planar member, each of the secondary planar members having a corresponding coupling member;
a mounting apparatus, having:
a set of fasteners, each fastener of the set of fasteners having a first and second parallel ends and a curved intermediate section, the curved intermediate section having a planar interior surface, the first and second parallel ends adapted to extend through the apertures in an aperture pair from the gate adjacent face to the gate opposite face; and
a set of parallel end fasteners coupled to the first and second parallel ends, the set of parallel end fasteners coupling the set of fasteners to the first planar member of the bracket.

10. The apparatus of claim 9,
wherein the planar interior surface of the set of fasteners abuts a tubular member of a gate when in use, and
wherein the coupling of the set of fasteners to the first planar member of the bracket is configured to removably affix the apparatus for mounting the accessory to the tubular member of the gate.

11. The apparatus of claim 10,
wherein the tubular member is a vertical tubular member, and
wherein the common axis is a transverse axis.

12. The apparatus of claim 11,
wherein the tubular member is a horizontal tubular member, and
wherein the common axis is a longitudinal axis.

13. The apparatus of claim 10, wherein the set of fasteners are flexible such that the interior surface of the set of fasteners is configured to adapt to a curved surface of the tubular member of the gate.

14. The apparatus of claim 9, the mounting apparatus further comprising a saddle bracket, having:
a planar surface that is configured to abut the gate adjacent face of the first planar member;
a curved portion opposite the gate adjacent face of the first planar member; and a saddle bracket aperture pair that corresponds to an aperture pair of the first planar member, each saddle bracket aperture in the saddle bracket aperture pair being an oblong shape,
wherein the first and second parallel ends are adapted to extend through the saddle bracket apertures in the saddle bracket aperture pair from the curved portion to the planar surface.

15. The apparatus of claim 9,
wherein the set of fasteners comprise a U-bolt,
wherein the first and second parallel ends are threaded; and
wherein the set of end fasteners comprise a nut.

16. The apparatus of claim 9, wherein the first and second secondary planar members are affixed to opposing lateral edges of the first planar member.

17. The apparatus of claim 9, wherein the first and second secondary planar members extend from the gate adjacent face of the first planar member.

18. The apparatus of claim 9, wherein the first and second secondary planar members extend from the gate opposite face of the first planar member.

19. An apparatus for mounting an accessory to a gate comprising:
a bracket having:
a first planar member, having:
a gate adjacent face;
a gate opposite face; and
a set of aperture pairs, each aperture pair of the set of aperture pairs having a pair of apertures oriented along a transverse axis of the first planar member, each aperture in the aperture pair being an oblong shape oriented along the transverse axis; and
a set of secondary planar members affixed to the first planar member such that each secondary planar member is oriented parallel to a longitudinal axis of the first planar member and extends perpendicularly outward from the first planar member, each secondary planar member having a coupling member;
a mounting apparatus, having:
a set of fasteners, each fastener of the set of fasteners having a first and second parallel ends and a curved intermediate section, the curved intermediate section having a planar interior surface, the first and second parallel ends adapted to extend through the apertures in an aperture pair from the gate adjacent face to the gate opposite face; and
a set of parallel end fasteners coupled to the first and second parallel ends, the set of parallel end fasteners coupling the set of fasteners to the first planar member of the bracket.
